(19) United States
(12) Patent Application Publication
(10) Pub. No.: US 2013/0142525 A1
(43) Pub. Date: Jun. 6, 2013

(54) IMAGE FORMING APPARATUS

(71) Applicants: Ken NONAKA, Tokyo (JP); Yoshiteru KAWAKAMI, Tokyo (JP); Takahiro OKUBO, Tokyo (JP); Haruki MOTEGI, Tokyo (JP); Masahiro MATSUO, Tokyo (JP); Yusuke KAWANAGO, Tokyo (JP); Osamu YOSHIMURA, Tokyo (JP)

(72) Inventors: Ken NONAKA, Tokyo (JP); Yoshiteru KAWAKAMI, Tokyo (JP); Takahiro OKUBO, Tokyo (JP); Haruki MOTEGI, Tokyo (JP); Masahiro MATSUO, Tokyo (JP); Yusuke KAWANAGO, Tokyo (JP); Osamu YOSHIMURA, Tokyo (JP)

(21) Appl. No.: 13/688,683

(22) Filed: Nov. 29, 2012

(30) Foreign Application Priority Data
Dec. 6, 2011 (JP) 2011-266994

(51) Int. Cl. G03G 15/00

(52) U.S. Cl. CPC G03G 15/6576
USPC 399/16; 399/406

(57) ABSTRACT

An image forming apparatus includes a fixing section, a de-curling section, and a control section. The de-curling section has a de-curling nip portion that presses a sheet to correct a curl caused in the sheet, and a corrective force thereof to press the sheet changes at least in two steps. The control section increases the conveyance speed of the sheet after a rear end of the sheet has passed the fixing nip portion when the de-curling section supports by sandwiching the sheet with a weakly-pressing force. When the de-curling section supports by sandwiching the sheet with a strongly-pressing force, the controller increases the conveyance speed of the sheet after the rear end of the sheet has passed the fixing nip portion and the de-curling nip portion.

### CROSS REFERENCES TO RELATED APPLICATIONS

The present invention contains subject matter related to Japanese Patent Application JP 2011-266994, filed in the Japanese Patent Office on Dec. 6, 2011, the entire contents of which being incorporated herein by reference.

### BACKGROUND OF THE INVENTION

1. Field of the Invention

The present invention relates to an image forming apparatus forming an image on a sheet, and in particular relates to an image forming apparatus having a correction device for correcting a curve caused in a sheet.

2. Description of the Related Art

In image forming apparatuses, for forming an image on a sheet, first a photoconductor is charged, and then an exposure is performed, i.e., a charge on the photoconductor is removed according an image of an original document, and thereby an electrostatic latent image is formed on the photoconductor. Then, a toner is caused to adhere to the latent image formed on the photoconductor using a development device, thereby forming a toner image on the photoconductor. The toner image formed on the photoconductor is transferred to a transfer member such as a sheet, etc., via an intermediate transfer belt or directly, and the toner image transferred, for example, to a sheet is then fixed to the sheet by a fixing device, thus forming an image on the sheet.

When the toner image is fixed to a sheet by the fixing device, heat and pressure are applied to the sheet, and therefore, the sheet is curled in one direction. Accordingly, on the downstream side of the fixing device in the sheet conveyance direction, a correction mechanism to correct a curl caused in a sheet by the fixing device (hereinafter referred to as a de-curling device) is arranged. A de-curling device supports a sheet by sandwiching it by a pair of rollers, and feeds the sheet. The de-curling device also applies a pressure to the sheet in a direction opposite to the direction in which the sheet has been curled by the fixing device.

Japanese Unexamined Patent Application Publication No. 6-156852 proposes a technique to change the pressure to be applied by the de-curling device to a sheet, according to the sheet quality. Also, when forming an image on each side of a sheet and when performing face-down (image-side down) sheet-discharging in which a side of a sheet is reversed, because the sheet needs to be conveyed to a sheet-reversing section, the sheet conveyance speed in the sheet conveyance section is increased. In the technique described in Japanese Unexamined Patent Application Publication No. 6-156852, the sheet conveyance speed is increased after the sheet has been conveyed through a fixing nip portion of the fixing device by the sheet conveyance section.

### SUMMARY OF THE INVENTION

However, in an linage forming apparatus described in Japanese Unexamined Patent Application Publication No. 6-155852, the sheet conveyance speed is increased regardless of the pressure applied to the sheet by the de-curling device. Further, the sheet conveyance speed is increased after the sheet has passed through the fixing nip portion even if the sheet is still being sandwiched by the de-curling device. Also, in the image forming apparatus described in Japanese Unexamined Patent Application Publication No. 6-156852, because the de-curling device sandwiches the sheet with a relatively high pressure, a relatively large load is added to a motor which rotationally-drives a de-curling roller of the de-curling device and a conveyance roller. As a result, the torque of a motor used in conveyance of the sheet needs to be increased, and thus a problem exists in that the motor becomes larger.

An object of the present invention is, in consideration of the actual conditions in the above-described background arts, to provide an image forming apparatus that can suppress the motor used for sheet conveyance from becoming larger.

To solve the above-described problem and to achieve the object of the present invention, an image forming apparatus of the present invention includes a fixing unit having a fixing nip portion for fixing a toner image to a sheet, a conveyance unit, a de-curling device, and a control unit.

The conveyance unit conveys a sheet on which a toner image has been fixed by the fixing unit.

The de-curling device is arranged on the downstream side of the fixing unit in the sheet conveyance direction, and has a de-curling nip portion that presses a sheet and corrects a curl caused in the sheet. The corrective force pressing a sheet changes in at least two steps.

The control unit controls the corrective force of the de-curling unit and the sheet conveyance speed in the conveyance unit. The control unit increases the sheet conveyance speed in the conveyance unit after a trailing end (rear-end) portion of the sheet in the sheet conveyance direction has passed through the fixing nip portion of the fixing unit, when the de-curling unit presses the sheet with a first pressure. The control unit increases the sheet conveyance speed in the conveyance unit after a trailing end (rear-end) portion of the sheet in the sheet conveyance direction has passed through the fixing nip portion of the fixing unit and the de-curling nip portion of the de-curling unit, when the de-curling unit presses the sheet with a second pressure which is higher than the first pressure,

### BRIEF DESCRIPTION OF THE DRAWINGS

FIG. 1 is a whole configuration diagram of an image forming apparatus according to an embodiment of the present invention.

FIG. 2A, FIG. 2B, and FIG. 2C are schematic configuration diagrams each illustrating a state around a fixing unit of the image forming apparatus. FIG. 2A illustrating a state that a sheet has been conveyed to the fixing unit and the de-curling unit, FIG. 2B illustrating a state that the sheet has passed through a fixing nip portion of the fixing unit, and FIG. 2C illustrating a state that the sheet has passed through a de-curling nip portion of the de-curling unit.

FIG. 3A and FIG. 3B are schematic configuration diagrams each illustrating the de-curling unit of the image forming apparatus. FIG. 3A illustrating a state of the de-curling unit when applying a weak pressure, and FIG. 3B illustrating the de-curling unit when applying a strong pressure.

FIG. 4 is a block diagram of a control system of the image forming apparatus.

FIG. 5 is a flowchart illustrating exemplary processing of changing the sheet conveyance speed in the image forming apparatus.

### DESCRIPTION OF THE PREFERRED EMBODIMENT

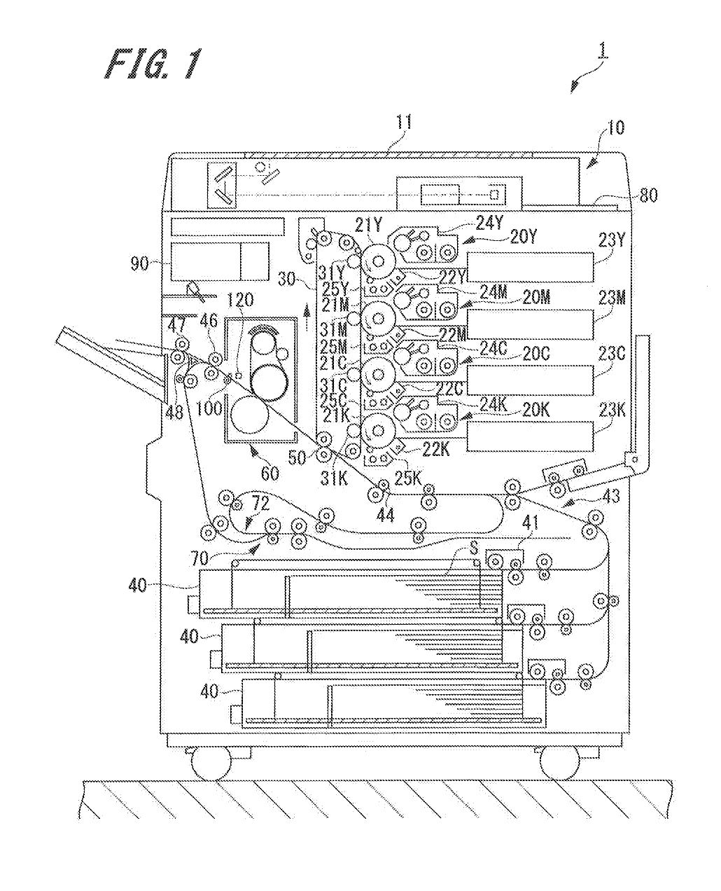

Below, description will be made with respect to an embodiment of an image forming apparatus referring to FIG. 1 through FIG. 5. In each of the drawings, common parts are denoted with the same reference symbols. Description herein will not limit the technical range and meaning of terms described in Claims.

1. Configuration Example of Image Forming Apparatus

First, a configuration example of an image forming apparatus 1 according to an embodiment of the present invention (hereinafter, referred to as the present embodiment) is described, referring to FIG. 1.

FIG. 1 is a whole configuration diagram of the image forming apparatus 1 in the present embodiment.

The image forming apparatus 1 illustrated in FIG. 1 is tandem-type color image forming apparatus, and forms a color image by superimposing each of four color toners of yellow (Y), magenta (M), cyan (c), and black (K) one after another.

The image forming apparatus 1 includes an image reading section 10, four image forming sections 20Y, 20M, 20C, and 20K, an intermediate transfer belt 30, sheet accommodation sections 40, a secondary transfer section 50, a fixing unit 60, and a sheet reversing section 70 performing switching-back of a sheet. The image forming apparatus 1 further includes an operation display section 80, and a control section 90.

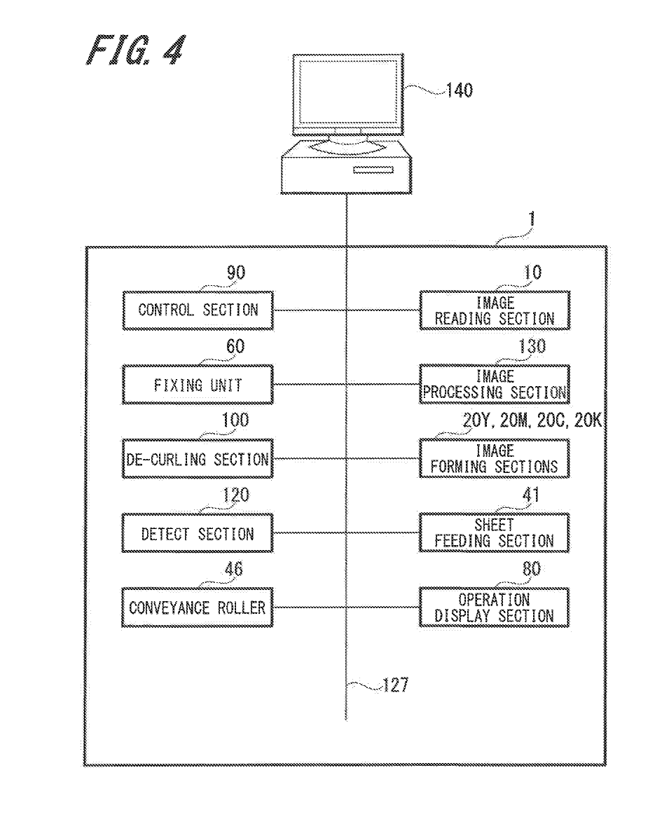

The image reading section 10 optically exposes an image of an original document placed on an original document platen 11 by optical scanning and guides the reflected light to an image sensor, where the entering light is photo-electrically converted to image information signals. The image information signals are transmitted to an image processing section 130 (see FIG. 4). The image processing section 130 applies analogue processing, A/D conversion, shading correction, image compression, etc. to the image information signals to generate image forming signals. The image forming signals are inputted to later-described light writing sections 23Y, 23M, 23C, and 23K of the image forming sections 20Y, 20M, 20C, and 20K.

The image forming section 20Y forms a toner image of yellow (Y), the image forming section 20M forms a toner image of magenta (M). The image forming section 20C forms a toner image of cyan (C), and the image forming apparatus 20k forms a toner image of black (K).

The image forming section 20Y includes a photoconductor drum 21Y, a charging section 22Y arranged around the photoconductor drum 21Y, a light writing section 23Y, a developing section 24Y, and a drum cleaner 25Y. The image forming section 20K includes a photoconductor drum 21K, a charging section 22K, a light writing section 23K a developing section 24K, and a drum cleaner 25K.

The photoconductor drums 21Y, 21M, 21C, and 21K, the charging sections 22Y, 22M, 22C, and 22K, the light writing sections 23Y, 23M, 23C, and 23K, the developing sections 24Y, 24M, 24C, and 24K, and the drum cleaners 25Y, 25M, 25C, and 25K respectively have common functions. Hereinafter, description will be made without putting symbols Y, M, C, and K except cases where distinction is needed.

The photoconductor drum 21 is rotated by a drive motor not shown. The charging section 22 applies a charge to the photoconductor drum 21 to uniformly charge the surface of the photoconductor drum 21. The optical writing section 23 performs an exposure to the surface of the photoconductor 21 according to image information signals to form an electrostatic latent image on the surface of the photoconductor drum 21.

The developing section 24 cause a toner to adhere to the electrostatic latent image formed on the photoconductor drum 21. Thereby, a toner image is formed on the surface of the photoconductor drum. The drum cleaner 25 removes the toner remaining on the surface of the photoconductor drum 21.

The toner image formed on the surface of the photoconductor drum 21 is transferred to the intermediate transfer belt 30 as an example of a transfer member. The intermediate transfer belt 30 is formed in an endless shape, and is rotated by a plurality of rollers in a direction opposite to the rotation direction of the photoconductor drum 21.

In positions of the intermediate transfer belt 30, opposing the photoconductor drums 21Y, 21M, 21C, and 21K of the image forming sections 20Y, 20M, 20C, and 20K, first transfer sections 31Y, 31M, 31C, and 31K are provided. Each of the first transfer sections 31Y, 31M, 31C, and 31K applies a charge having the polarity opposite to that of the toner, and thereby a toner image formed on each photoconductor drum 20 is transferred to the intermediate transfer belt 30.

Then, by rotation of the intermediate transfer belt 30, toner images formed on the photoconductor drums 21Y, 21M, 21C, and 21K are sequentially transferred onto the surface of the intermediate transfer belt 30, and thereby a color image in which toner images of Y (yellow), M (magenta), C (cyan), and K (black) have been superimposed one on top of another is formed on the surface of the intermediate transfer belt 30.

Below the image forming sections 20Y, 20M, 20C, and 20K, a plurality of the sheet accommodation sections 40 are arranged according to sizes of the sheet S. Each sheet S is fed by a sheet feeding section 41 and is conveyed to the conveyance section 43. Then, the sheet S is conveyed via a registration roller 44 to the secondary transfer section 50 serving as a transfer position.

The secondary transfer section 50 is formed in a roller-like shape, and presses the sheet S conveyed via the registration roller 44 to the intermediate transfer belt 30. Thereby, onto the sheet S, a color toner image on the intermediate transfer belt 30 is transferred.

On the sheet-discharging side of the secondary transfer section 50, the fixing section 60 is provided. The fixing section 60 fixes a toner image having been transferred onto a sheet S to the sheet S by pressure and heat. The sheet S to which the toner image has been fixed is subjected to correction of curling in the sheet S with a de-curling device 100, and is then discharged, after passing a conveyance roller 46 and a discharging roller 47, to the outside of the apparatus. Details of the configuration of the fixing section 60 and the area surrounding the fixing section 60 will be described later.

On the downstream side of the conveyance roller 46 in the conveyance direction of the sheet S, a switching gate 48 is arranged. The switching gate 48 switches the conveyance direction of the sheet S that has passed the conveyance roller 46.

That is, when performing face-up discharging in one-side image formation, the switching gate 48 allows the sheet S to be conveyed straight. Thereby, the sheet S is discharged by the discharging roller 47. Here, face-up discharging means discharging a sheet with the side on which an image has been formed faced up.

When performing face-down sheet discharging in one-side image formation, so-called reverse sheet discharging, or both-side image formation, the switching gate 48 switches the conveyance direction and guides the sheet S to a reversing section 70. Face-down discharging means discharging a sheet S with the side on which an image has been formed faced down.

The reversing section 70 reverses the conveyance direction of the sheet S, and thereby reverses the front and the back of the sheet S.

When performing face-down discharging, the sheet S reversed upside down by the reversing section 70 is guided to the switching gate 48 and is then discharged by the discharging roller 47. When performing both-side image formation, the sheet S revered upside down with the reversing section 70 is conveyed to the transfer position via a re-conveyance path 72 provided on the downstream side of the reversing section 70 after the sheet S has been reversed upside down.

The operation, display section 80 includes a touch panel, etc., and functions as an input section to input job information for causing the image forming apparatus 1 to be operated. The operation display section 80 is capable of inputting as job information selection of sizes and thicknesses of sheets S, selection of the number of sheets S, selection of one-side image formation or two-side image formation, etc. The job information inputted at the operation display section 80 is transmitted to the control section 30.

The operation display section 80 includes a start button. The user inputs job information through the operation display section 30, and depresses the start button. Thereby, the image forming apparatus 1 starts an operation based upon the inputted job information. The control section 90 controls an image forming operation of the image forming apparatus 1, based on the received job information.

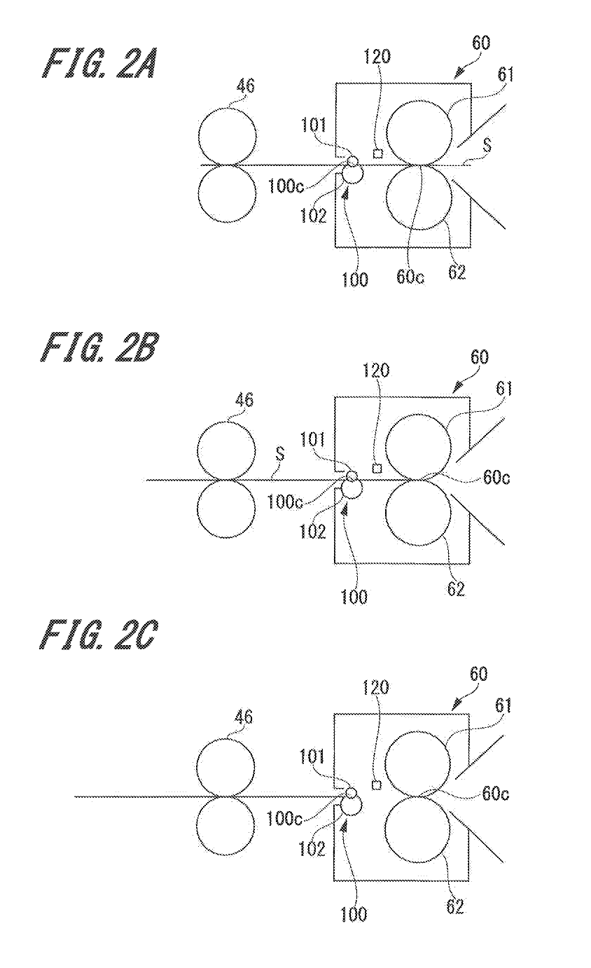

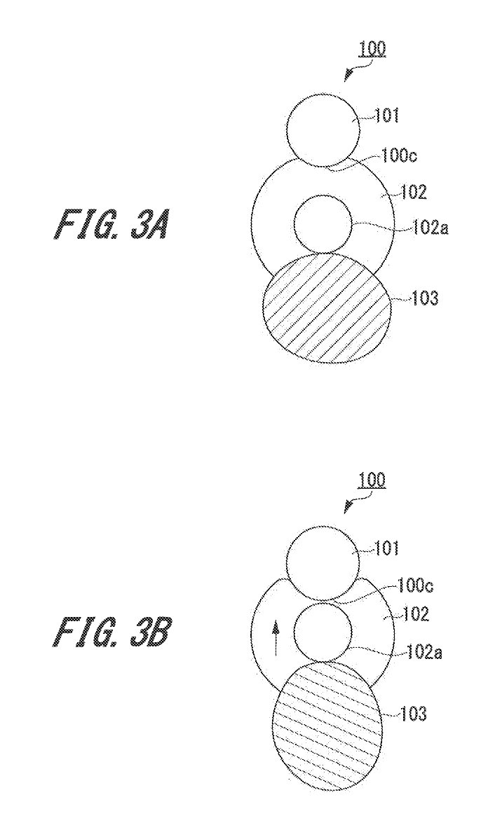

Next, description is made with respect to the detailed configuration of the fixing section 60 and the area surrounding the fixing section 60, referring to FIG. 2A, FIG. 3A, and FIG. 3B.

FIG. 2A is a schematic configuration diagram illustrating the configuration of the fixing section 60 and the area surrounding the fixing section 60, and FIG. 3A and FIG. 3B are schematic configuration diagrams each illustrating the configuration of the de-curling section.

As illustrated in FIG. 2A, the fixing section 60 includes a fixing roller 61 that is rotatable, and a pressing roller 62 that is rotatable and that is pressed against and contacts the fixing roller 61 to form a fixing nip portion 60C. Inside the fixing roller 61, for example, a heat source, such as a halogen lamp, etc., is provided. The fixing roller 51 is heated by the heat source.

The fixing section 60 sandwiches a sheet S carrying a toner image at the fixing nip portion 60c and heats the toner image on the sheet S with the fixing roller 61 that is heated, and thereby fixes the toner image to the sheet S. The fixing roller 61 and the pressing roller 62 are rotated in directions opposite to each other, and thereby the toner image is fixed to the sheet S and the sheet S is conveyed.

On the downstream side of the fixing section 60 in the conveyance direction of the sheet S, the de-curling section 100 is provided. As illustrated in FIG. 3A, the de-curling section 100 includes a de-curling roller 101 that is rotatable, a soft roller 102 that is rotatable and that is pressed against and contacts the de-curling roller 102 to form a de-curling nip portion 100c, and a drive mechanism not shown in figure, that operates the soft roller 102. The de-curling section 100 corrects curling in the sheet S, which has been caused by the fixing section 60, and at the same time has a role as the conveyance section to convey the sheet S. The de-curling roller 101 is rotated by a motor not shown in figure.

The soft roller 102 is formed of a material that is softer than the de-curling roller 101, and presses the de-curling roller 101 with a predetermined pressure. A curled sheet S is sandwiched at the de-curling section 101c, and the sheet S is pressed from a direction opposite to the direction in which the sheet S has been curled. Thereby, the curling in the sheet S is corrected. The soft roller 102 and the de-curling roller 101 are rotated in directions opposite to each other, and thereby the curling of the sheet S is corrected and at the same time the sheet S is conveyed. The distance between the fixing nip portion 60c of the fixing section 60 and the de-curling portion 100c of the de-curling section 100 is set shorter than the length of the sheet S in the direction parallel with the conveyance direction of the sheet S.

Further, a cam rotation body 103 constituting a roller drive mechanism is in contact with a rotation axis 102a of the soft roller 102. By rotation of the cam rotation body 103, the rotation axis 102a comes close to or separates from the de-curling roller 101. Then, it is possible to change the pressure that the soft roller 102 presses the de-curling roller 101 by causing the rotation axis 102a to come close to or to separate from the de-curling roller 101.

In FIG. 3A, the soft roller 102 presses the de-curling roller 101 with the first pressure, and thus FIG. 3A illustrates a weakly-pressed state of the de-curling section 100. In FIG. 3B, the rotation axis 102 of the soft roller 102 is closer to the de-curling roller 101 compared with the state illustrated in FIG. 3A. Accordingly, the soft roller 102 presses the de-curling roller 101 with the second pressure that is higher than the first pressure. The state of the de-curling section 100 illustrated in FIG. 3B is called a strongly-pressed state. The corrective force of the de-curling section 100 thus changes in two steps, namely, a weakly-pressing step and a strongly-pressing step.

The corrective force of the de-curling section 100 may be changed not only in two steps but also in three steps or more. Further, in order to change the corrective force of the de-curling section 100, a cam mechanism has been used, however, the present invention is not limited to this, and the corrective force of the de-curling section 100 may be changed using a motor, a gear, etc.

Further, as illustrated in FIG. 2A, a detector 120 is provided between the de-curling section 100 and the fixing roller 61 and the pressing roller 62 of the fixing section 60. The detector 120 detects a leading end of the sheet S in the sheet conveyance direction. Then, the detector 120 transmits sheet conveyance information of the sheet S that has been detected to the control section 90.

On the downstream, side of the de-curling section 100 in the conveyance direction of the sheet S, a pair of conveyance rollers 46 constituting a conveyance section is provided. The pair of conveyance rollers 46 is rotationally driven by a motor not shown. The pair of conveyance rollers 46 sandwiches the sheet S and is driven in directions opposite to each other, thus performing conveyance of the sheet S.

2. Control System Configuration Example of Image Forming Apparatus

Next, description is made with respect to the control system, configuration of the image forming apparatus 1, referring to FIG. 4.

FIG. 4 is a block diagram illustrating the control system of the image forming apparatus 1.

As illustrated in FIG. 4, the image forming apparatus 1 includes the control section 90 and the operation display section 80. The control section 90 is provided with a ROM (Read Only Memory), a RAM (Random Access Memory) which is used as a working area of the control section 90, etc. The control section 90 is connected with the image reading section 10, the image processing section 130, the image forming sections 20Y, 20M, 20C, and 20K, the sheet accommodation sections 40, the conveyance roller 46, the fixing section 60, the operation display section 80, the de-curling section 100, and the detector 120, via a system bus 123. The control section 90 controls the whole parts of the apparatus.

The operation display section 80 is a touch panel display constituted of a liquid crystal display (LCD) device, an organic electro luminescence display (ELD), etc. The operation display section 80 displays instruction menus for the user, information on obtained image data, etc. The operation display section 80 is provided with keys, and accepts inputting of data carried out through the operation of keys, such as various kinds of instructions, characters, numerals, etc., and outputs inputted signals.

The image reading section 10 optically reads an image of an original document and converts the optical information to electrical signals (image data). Image data generated by the image reading section 10 and image data transmitted from a PC (personal computer) 140 as an example an external apparatus connected with the image forming apparatus 1 is transmitted to the image processing section 130 and is subjected to image processing. The image processing section 130 carries out processing to the image data, such as analogue processing, A/D conversion, shading correction, image compression, etc.

In the present embodiment, a case has been explained in which a personal computer is used as the external apparatus. However, a facsimile apparatus and other various apparatus may be used as the external apparatus.

The image forming sections 20Y, 20M, 20C, and 20K receive image data subjected to image processing at the image processing section 130, and form toner images of respective colors.

As described above, the de-curling section 100 and the detector 120 are connected with the control section 30 via the system bus. The control section 90 controls the sandwiching pressure to the sheet S in the de-curling section 100 based on instruction information from the operation display section 80.

Also, conveyance information of the sheet S is transmitted from the detector 30 to the control section 90. The control section 90 calculates and sets timing of changing the conveyance speed of the sheet S based on transmitted the conveyance information of the sheet and the information of sheet sandwiching pressure at the de-curing section 100. Then, the control section 90 changes the rotation speed of the de-curling section 100 and the conveyance roller 46 based on the calculated timing, thus changing the conveyance speed of the sheet S.

3. An Example of Processing of Image Forming Apparatus

Next, an example of processing of changing the conveyance speed of the sheet S that has passed the fixing section 60 of the image forming apparatus 1 of the present embodiment will be described referring to FIG. 2A through FIG. 5.

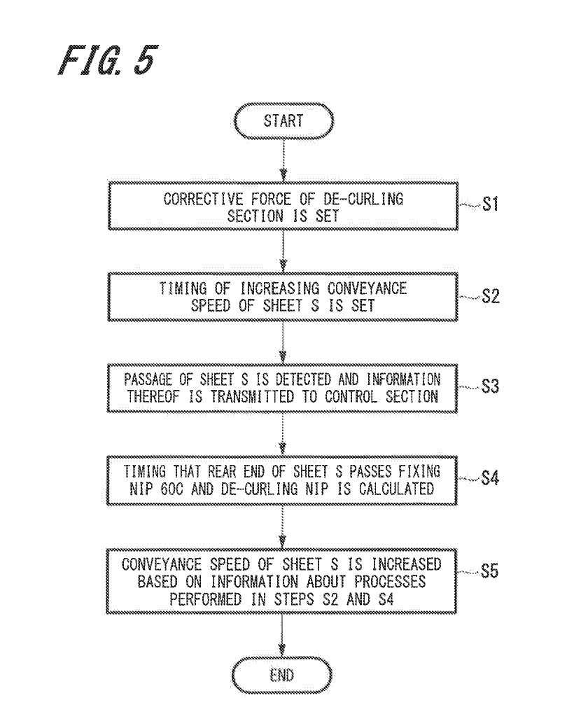

FIG. 5 is a flowchart illustrating an example of processing of changing the conveyance speed of the sheet S in the image forming apparatus 1.

As illustrated in FIG. 5, when correcting curling of a sheet S, the pressure to be applied by the de-curling section 100 to the sheet S, i.e., the corrective force, is set (step S1). For example, when the sheet S is a paper having the thickness equal to or more than a predetermined thickness (hereinafter, called a cardboard), the sheet S will not be curled much when the sheet S is fed through the fixing section 60. Therefore, the control section 90 controls the corrective force of the de-curling section 100 to a weakly-pressing force (see FIG. 3A), which is a first pressing force.

In contrast, when the sheet S is a paper having the thickness not greater than a predetermined thickness (herein after called a thin paper), the sheet S will be greatly curled when the sheet S is fed through the fixing section 60. Therefore, the sheet S needs to be supported by being sandwiched with a stronger pressure as compared with the case that the sheet S is a cardboard. Accordingly, the control section 90 controls the corrective force of the de-curling section 100 to a strongly-pressing force (see FIG. 3B), which is a second pressure stronger than the first pressure.

The corrective force of the de-curling section 100 can be set based on, not only the thickness of the sheet S, but also, the basis weight, paper quality, size, etc, of the sheets. That is, the control section 90 controls the corrective force of the de-curling section 100 based on information of the sheet S relating to at least one of thickness, basis weight, paper quality, size of the sheet S.

Next, the control section 90 sets a timing of increasing the conveyance speed of the sheet S (increasing the rotation speed of the de-curling roller 101 and the conveyance roller 46) according to the corrective force of the de-curling section 100 (step S2).

When the corrective force of the de-curling section 10 is weak, because the load applied to the sheet S or the de-curling roller 101 is relatively small, an excessive load will not be applied to the motor of the de-curling roller 101 and the conveyance roller 46 even if the conveyance speed of the sheet S is increased in a state that the sheet S is supported by being sandwiched by the de-curling section 100. Accordingly, the control unit 90 sets the timing of increasing the conveyance of the sheet S such that the rotation speeds of the de-curling roller 101 and the conveyance roller 46 are increased when the rear end of the sheet S has passed the fixing nip portion 60c as illustrated in FIG. 2B.

When the corrective force of the de-curling section 100 is strong, the load applied to the motor rotating the conveyance roller 46 and the de-curling roller 101 become large. Therefore, the rotation speed of the conveyance roller 46 is increased after the rear end of the sheet S has passed not only the fixing nip portion 60c but also the de-curling nip 100c as illustrated in FIG. 2C. Thereby, it is prevented that an excessive load is applied to the motor of the de-curling roller 101 and the conveyance roller 46.

Next, the sheet S is conveyed to the fixing section 60 and the de-curling section 100. At this time, the detect section 120 detects the sheet S, and transmits information thereof to the control section 90 (step S3). In this embodiment, the detect section 120 detects a leading end in the sheet conveyance direction of the sheet S.

The control section 90 calculates the timing that the rear end of the sheet S in the conveyance direction of the sheet S passes the fixing nip 60c and the de-curling nip 100c based on the information on the sheet S detected by the detect section 120 (step S4). Specifically, the control section 90 calculates the timing that the rear end of the sheet S passes the fixing nip 60c and the de-curling nip 100c based on the timing that the leading end of the sheet S has passed the detect section 120 and the length in the conveyance direction of the sheet S.

In this embodiment, description has been made with respect to the example in which the detect section 120 detects the leading end of the sheet S, however, the invention is not limited to this. For example, it may be configured such that the detect section 120 detects the rear end in the conveyance direction of the sheet S. In this case, it is preferable that the detect section 120 is arranged near the fixing nip 60c of the fixing section 60. Then, it may be determined as that the rear end of the sheet S has passed the fixing nip 60c when the detect section 120 detects the rear end of the sheet S. The timing that the sheet S passes the de-curling nip 100c of the de-curling section 100 is calculated based on the timing that the detect section 120 has detected the rear end of the sheet S and the distance from the detect section 120 to the de-curling nip 100c.

Also, a second detect section that detects the rear end of the sheet S may be provided near the de-curling nip 100c. In this case, whether or not the rear end of the sheet S has passed the de-curling nip 100c may be determined by the second detect section.

Next, the conveyance speed of the sheet S may be increased based on the timing of increasing the conveyance speed of the sheets S that has been set in step S2 and the timing that the rear end of the sheet S passes the fixing nip portion 60c and the de-curling nip portion 100c that has been calculated in step S4 (step S5).

That is, when the corrective force of the de-curling section 100 is a weakly-pressing force, when the rear end of the sheet S has passed the fixing nip portion 60c as illustrated in FIG. 2B, the rotation speeds of the de-curling section 100 (de-curling roller 101) and the conveyance roller 46 are increased. Thereby, the conveyance speed of the sheet S can be increased.

In contrast, when the corrective force of the de-curling section 100 is a strongly-pressing force, the rotation speed of the conveyance roller 46 is increased after the rear end of the sheet S has passed the fixing nip portion 60c and the de-curling nip portion 100c, and thereby the conveyance speed of the sheet S is increased as illustrated in FIG. 2C. Thereby, the torque of the motor that rotationally drives the conveyance roller 46 and the de-curling roller 101 can be alleviated, and thus, the motor can be suppressed from growing in size.

In the above-described processing example, description has been made with respect to the example in which the conveyance speed of the sheet S is always changed, however, the present invention is not limited to this. For example, depending on whether face-up discharging in one-side image formation is performed, or face-down discharging in one-side image forming or both-side image formation is performed, whether or not to increase the conveyance speed of the sheet S is determined. That is, when performing face-up discharging in one-side image formation, the sheet S needs not be conveyed to the reversing section 70, so that even if the conveyance speed of the sheet S is not increased, waiting time is not caused, in processing sections.

In contrast, when performing face-down discharging or both-side image formation, the sheet S needs to be conveyed to the reversing section 70, so that in order to alleviate waiting time in each processing section, the conveyance speed of the sheet S needs to be increased. Therefore, when performing face-down discharging or both-side image formation, as illustrated in FIG. 5, the conveyance speed of the sheet S is increased according to the pressing state of the de-curling section 100.

Further, the corrective force of the de-curling section 100 may be determined based on not only the paper quality of the sheet S but also the finished conditions of the sheet S, such as placing a priority on productivity or placing a priority on flatness of the sheet S. Specifically, when the number of sheets S for image formation is relatively large, or some curling in the sheet S is allowed, the corrective force of the de-curling section 100 is set to the weakly-pressing force, placing the priority on productivity. Then, the conveyance speed of the sheet S is increased when the sheet S has passed the fixing-nip portion 60c, thus increasing the productivity.

In contrast, when even some curling in the sheet S is not allowed, i.e. , when the priority is put on flatness of the sheet S, the corrective force of the de-curling section 100 is set to the strongly-pressing force. Then, the conveyance speed of the sheet S is increased when the sheet S has passed the fixing-nip portion 60c and the de-curling section 100c.

Description has been made above on an embodiment of an image forming apparatus, including operations and effects thereof. However, the image forming apparatus of the present invention is not limited to the above-described embodiment, and various changes and modifications are possible within the scope of the gist of the invention described in claims.

The above-described image forming apparatus 1 is configured to form a color image using the image forming sections 20Y, 20M, 20C, and 20K, however, an image forming apparatus according to the present invention may be configured to form a single color image using a single image forming section.

The above-described image forming apparatus 1 includes an intermediate transfer belt as a transfer member onto which a toner image formed on a photoconductor is transferred, and is configured to transfer the toner image from the intermediate transfer belt to a sheet. However, an image fencing apparatus according to the present invention may be configured to transfer a toner image formed on a photoconductor directly to a sheet.

What is claimed is:

1. An image forming apparatus comprising:
a fixing section having a fixing nip portion that fixes a toner image on a sheet to the sheet;
a conveyance section configured to convey the sheet onto which the toner image has been fixed by the fixing section;
a de-curling section arranged on a downstream side of the fixing section in a conveyance direction of the sheet and having a de-curling nip portion that presses the sheet to correct a curl caused in the sheet, a corrective force thereof to press the sheet changing at least in two steps; and
a control section configured to control a conveyance speed of the sheet in the conveyance section, and the corrective force of the de-curling section, wherein the control section increases the conveyance speed of the sheet in the conveyance section after a rear end of the sheet in the conveyance direction of the sheet has passed the fixing nip portion of the fixing section when the de-curling section presses the sheet with a first pressure, and when the de-curling section presses the sheet with a second pressure that is higher than the first pressure, increases the conveyance speed of the sheet in the conveyance section after the rear end of the sheet in the conveyance direction of the sheet has passed the fixing nip portion of the fixing section and the de-curling nip portion of the de-curling section.

2. The image forming apparatus according to claim 1, further comprising a detect section arranged between the fixing section and the de-curling section and configured to detect passing of the sheet, the control section calculating a timing that the rear end of the sheet passes the fixing nip portion and the de-curling nip portion based on information on the passing of the sheet detected by the detect section.

3. The image forming apparatus according to claim 2,
wherein the detect section detects a leading end of the sheet in the conveyance direction of the sheet, and
wherein the control section calculates a timing that the rear end of the sheet passes the fixing nip portion and the de-curling nip portion based on a riming that the leading end of the sheet has been detected by the detection section and a length of the sheet in a direction parallel with the conveyance direction of the sheet.

4. The image forming apparatus according to claim 1, wherein the control section changes the corrective force of the de-curling section based on information on at least one of thickness, paper quality, basis weight, and size of the sheet.

5. The image forming apparatus according to claim 1, wherein the conveyance speed of the sheet is increased when the sheet on which an image has been formed is reversed to be discharged or when forming an image on each side of the sheet.

6. The image forming apparatus according to claim 1, wherein the control section changes the corrective force of the de-curling section based on finished conditions of the sheet.
